(19) United States
(12) Patent Application Publication
(10) Pub. No.: US 2003/0111021 A1
(43) Pub. Date: Jun. 19, 2003

(54) Animal experiment method

(76) Inventor: Ru-Ping Lee, Hua-Lien (TW)

Correspondence Address: EDWARDS & ANGELL, LLP, P.O. BOX 9169, BOSTON, MA, 02209, US

(21) Appl. No.: 10/140,963

(22) Filed: May 8, 2002

(30) Foreign Application Priority Data
Dec. 13, 2001 (TW) 90130865

(51) Int. Cl. A01K 1/03

(52) U.S. Cl. 119/417

(57) ABSTRACT

An animal experiment method is proposed, in which a live test animal is prepared, and at least one tube is intubated into a body of the test animal, wherein one end of the tube comes into contact with body fluid of the test animal, and the other end of the tube is exposed to outside of the test animal. And, a monitoring system is connected to the exposed end of the tube, so as to monitor instant physiological conditions of the test animal in a limited space. Since the test animal stay alive and conscious during entire experiment, no anesthetic is necessarily applied to the test animals, and no undesirable interference caused by anesthetics with animal physiological mechanisms is generated. Therefore, experimental results can truly reflect real physiological and pharmaceutical conditions of the test animals, thereby making experimental data more reliable and significant for use as clinical reference.

### FIELD OF THE INVENTION

The present invention relates to animal experiment methods, and more particularly, to an animal experiment method for examining physiological conditions and variations of live and conscious test animals.

### BACKGROUND OF INVENTION

Generally, animal experiment methods are purposed in examining physiological and pharmacological actions of test animals induced by pharmaceuticals or external stimuli (such as electric shocks or pathogens), which allows human reactions possibly generated under the same conditions to be predicted, and further can be used as reference to clinical experiment imitation. Conventional animal experiment methods are performed in a conscious model or an anesthetic model. In the conscious model, medicine is administered to test animals by feeding, subcutaneous injection, abdominal injection and tail veinous injection, as well as the test animals are implanted in skins thereof with chips, or subjected to external stimuli such as electric shocks or temperature variations, so as to investigate behaviors and responses of the experimented test animals. This conscious model is advantageous in that, since the test animals are live and conscious during experiment, physiological variations are purely caused by the effects of medicine administered to the test animals in exclusion of other external factors, so that physiological parameters obtained in the experiment can truly reflect real situations in bodies of the test animals. Further, the conscious model of experiment is usually manipulated in a low invasive manner, which is less harmful to the test animals and can prevent them from being infected or dying in the experiment. However, this conscious model of experiment is endowed with significant drawbacks. For example, only final results of the test animals after being administered with medicine can be investigated, but instant physiological changes of e.g. plasma and internal metabolite concentrations during medicine administration cannot be immediately and continuously monitored. Therefore, in practice, such a conscious model is not as widely applied as the anesthetic model of experiment.

In the anesthetic model of experiment, test animals are allowed to inhale or be administered with anesthetic, and then hold in position on operation platforms. Intubation operations or tests are performed for the test animals; by virtue of intubation and apparatus monitoring, various biochemical values or physiological and pharmacological actions induced by medicine administration can be investigated and detected; this is beneficial for obtaining deep clinical analysis data. However, a primary drawback of the anesthetic model manipulation is the presence of the anesthetic that interferes with animal physiological mechanisms, whereby experimentally obtained results are low in correspondence with real biochemical values or clinical situations.

Moreover, for examining physiological and pharmacological responses of test animals at certain time points, such as two hours after medicine administration, current methods are mostly to sample and sacrifice the test animals when approaching the time points. However, this often causes inaccuracy in obtained results due to timing errors of sampling the test animals, and also animal physiological variations during time intervals cannot be instantly detected. In addition, the test animals usually suffer much emotional stress before being sacrificed, whereby various internal physiological mechanisms thereof become abnormal, making experimental results not able to honestly reflect real physiological situations in the test animals. Further, in concern of statistical significance of experimental results, multiple time-point experiments are often continuously carried out with a large amount of animals being sacrificed; this undesirably increases experimental costs, and is extremely not in compliance with ethical concern.

### SUMMARY OF THE INVENTION

A primary objective of the present invention is to provide an animal experiment method, in which live and conscious test animals can be immediately blood-sampled under metal steady conditions, allowing internal physiological variations to be instantly monitored and detected.

Another objective of the invention is to provide an animal experiment method, in which no anesthetic is administered to test animals, so that animal physiological mechanisms are not interfered by anesthetic effects, making experimental results more reliable and reflective of real internal physiological situations in the test animals.

A further objective of the invention is to provide an animal experiment method, in which much less test animals are sacrificed, whereby experimental costs can be significantly reduced, and the animal experiment method is more compliant to ethical concern.

In accordance with the above and other objectives, the present invention proposes an animal experiment method, comprising the following steps. First, a live test animal such as a rat is prepared, and at least one tube is intubated into a body of the live test animal, wherein one end of the tube comes into contact with body fluid of the live test animal, and the other end of the tube is exposed to outside of the live test animal. Then, limbs of the live test animal are tied up for restricting movement of the live test animal within a limited space. And, the exposed end of the tube is connected to a monitoring system, whereby the monitoring system is used to monitor instant physiological conditions of the live test animal under a movement restricted situation.

The animal experiment method of the invention is characterized of integrating advantageous and benefits of both conventional conscious and anesthetic models of experiment. As compared to the prior art of sacrificing and sampling test animals at certain time intervals, the animal experiment method of the invention can continuously monitor physiological conditions of test animals during the entire test performance, so that current internal body variations are easily controlled, and thus the drawback in the prior art of inability to detect animal body situations during time intervals can be eliminated. Moreover, since test animals stays alive and conscious during the entire experiment, thus no anesthetic is necessarily applied to the test animals, and no undesirable interference caused by anesthetics with animal physiological mechanisms is generated; this allows experimental results to truly reflect real physiological and pharmaceutical conditions of the test animals, thereby making experimental data more reliable and significant for use as clinical reference. In addition, as test animals are intubated with tubes before test performance, thus blood sampling or fluid inputting can be easily implemented by using externally connected devices during experiment operation. This not only reduces operational disturbance to the test animals and undesirable factors affecting experimental results, but also provides an experimental environment more suitably applied for feeding live animals.

### BRIEF DESCRIPTION OF THE DRAWINGS

The present invention can be more fully understood by reading the following detailed description of the preferred embodiments, with reference made to the accompanying drawings wherein:

FIG. 1 is a schematic flowchart showing the steps involved in performing an animal experiment method of the invention;

FIG. 2 is a top view of a test animal in accompany with an internal magnified view of an intubation position of the test animal used in an animal experiment method of the invention;

FIG. 3A is a side view of an animal feeding cavity used in an animal experiment method of the invention;

FIG. 3B is a back view of an animal feeding cavity used in an animal experiment method of the invention;

FIG. 4 is a top view of a wire mesh floor used in an animal experiment method of the invention;

FIG. 5 is a simplified schematic diagram showing connection between a test animal and an external monitoring system used in an animal experiment method of the invention; and

FIG. 6 is a side schematic diagram showing a test animal being performed with an animal experiment method of the invention.

### DETAILED DESCRIPTION OF THE PREFERRED EMBODIMENT

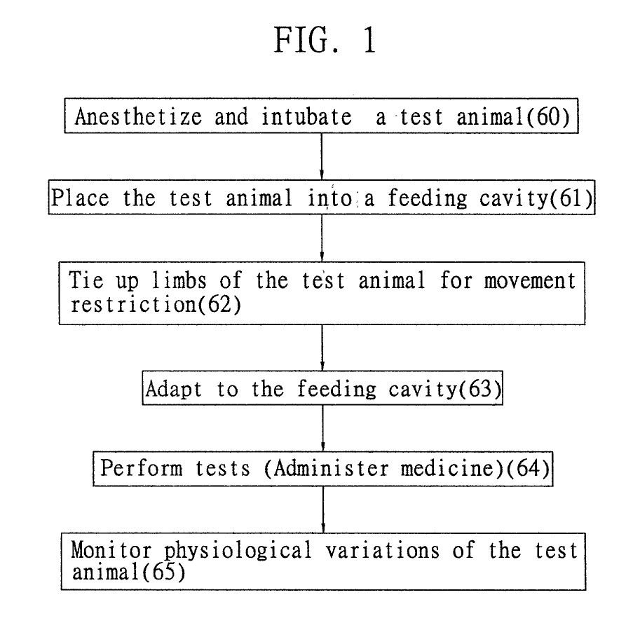

FIG. 1 illustrates the steps involved in performing an animal experiment method of the present invention. As shown in steps 60 to 65, the animal experiment method of the invention is firstly to perform an intubation operation on a test animal that is formed at its skin with at least one tube portion exposed to outside. Then, the test animal is moved to a feeding cavity, with its limbs being tied up for movement control. After the test animal well adapts to the feeding cavity and reaches physical and mental steadiness, the exposed tube portion is connected to an external monitoring system. Subsequently, medicine or an experimental stimulus can be administered to the test animal, so as to continuously monitor and detect various physiological and pharmaceutical variations in the test animal. The steps of the animal experiment method of the invention are described in more detail as follows.

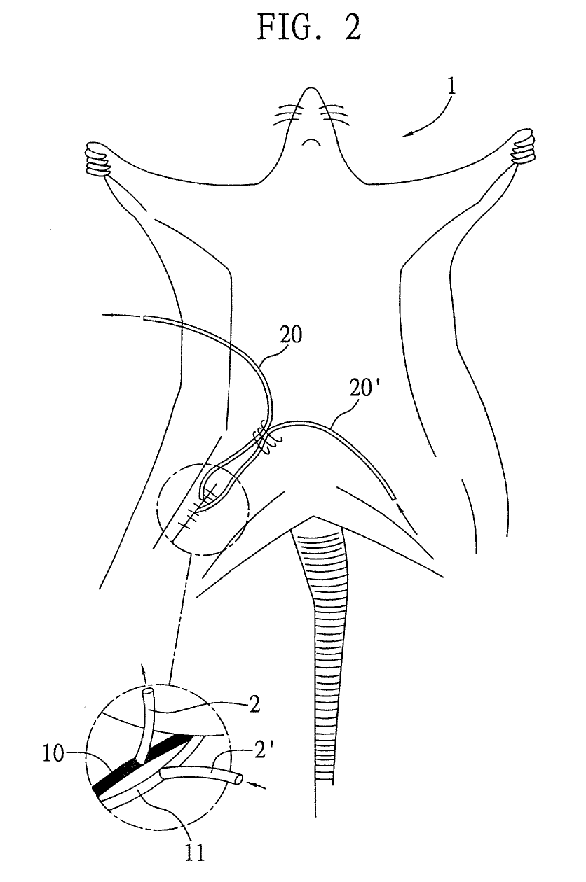

As shown in FIG. 2, a plurality of live animals 1 e.g. WKY rats and guinea pigs are selected as subjects (hereinafter referred to test animals 1) for experimental investigation use. Species of the test animals 1 are not particularly limited, purely depending on experimental requirements. For the sake of clarification and simplicity, rats are exemplified herein as test animals used in the animal experiment method of the invention. First, among a plurality of rats pre-growing in a cage, one rat 1 is taken out of the cage, and anesthetized for temporary loss of consciousness. Then, the rat 1 is operated with intubation at its thigh artery 10 and thigh vein 11, allowing a plurality of tubes 2, 2′ to be intubated into the thigh artery and vein 10, 11, where medicine can be injected along an inlet arrow and blood can be diverted along an outlet arrow indicated in the drawing. Since the foregoing anesthetization and intubation techniques are conventional, no further description thereof is to be detailed herein. After the intubation operation is completed, a wound of the rat 1 is seamed, and the tubes 2, 2′ are fixed in position, with one end of each of the tubes 2, 2′ being exposed to outside to form an exposed tube portion 20, 20′. It is ready to proceed the animal experiment method of the invention.

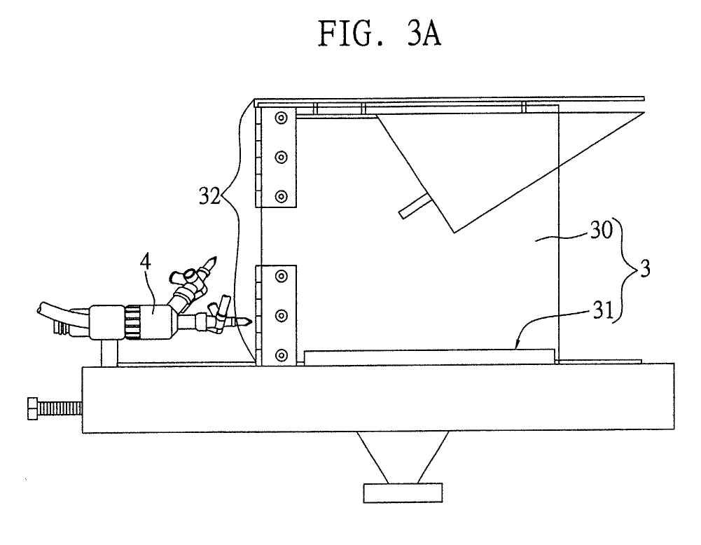

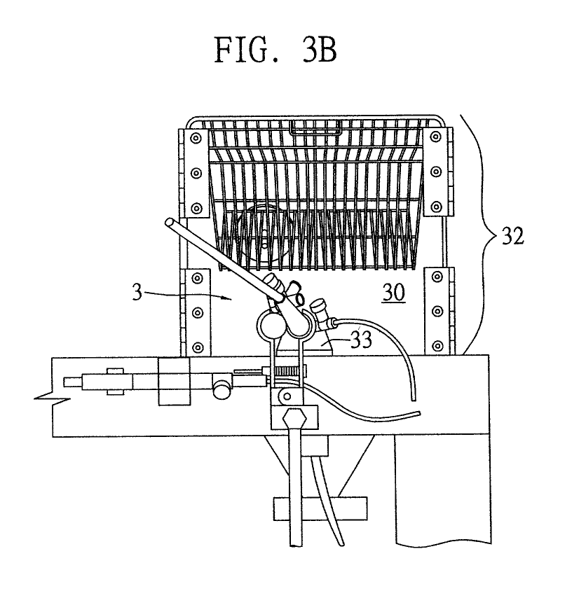

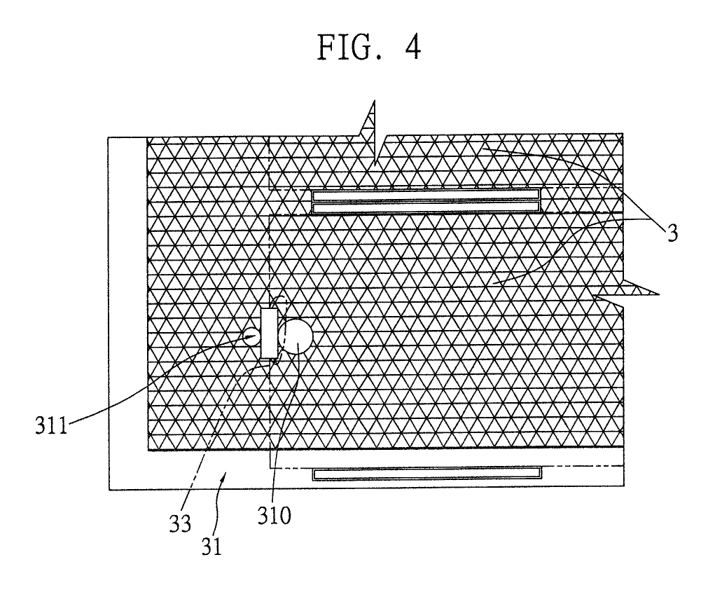

As shown in FIGS. 3A (side view) and 3B (back view), a feeding cavity 3 is prepared for the rat 1 (not shown) to live therein. The feeding cavity 3 is composed of more than one piece of rigid board 30 and a wire mesh floor 31 that is connected to and erects the rigid board 30. Water and feed (not shown) are provided in the feeding cavity 3 in such a manner as same as those for pre-growing the rat 1, so as to make the rat 1 (not shown) feel easy and free to eat. Different rigid boards 30 are assembled in advance to fashion a barrier wall 32, which can be formed with a board aperture 33 for allowing a tail of the rat 1 (not shown) to penetrate therethrough, and a movable door (not shown) for facilitating the rat 1 to be moved therethrough into the feeding cavity 3. The wire mesh floor 31 is made in a platform structure shown in FIG. 4, on which multiple sets of barrier walls 32 (not shown) formed of rigid boards 30 are disposed to construct separate feeding cavities 3, whereby a plurality of rats (not shown) can be individually placed in the different feeding cavities 3 and simultaneously undergo experiment processes. Moreover, the wire mesh floor 31 is formed with a row of drain holes 310 and a row of through holes 311 in a manner that, a pair of a drain hole 310 and a through hole 311 are respectively positioned at front and rear of the board aperture 33 of the feeding cavity 3. After the intubated and unconscious rat 1 (not shown) is placed in the feeding cavity 3, its tail (not shown) accompanied with an intubated tube portion (not shown) are allowed to penetrate through the board aperture 33 and the through hole 311 to be fixed underneath the wire mesh floor 31; this restricts movement of the rat 1 and prevents the tube portion (not shown) from being detached from skin of the rat 1.

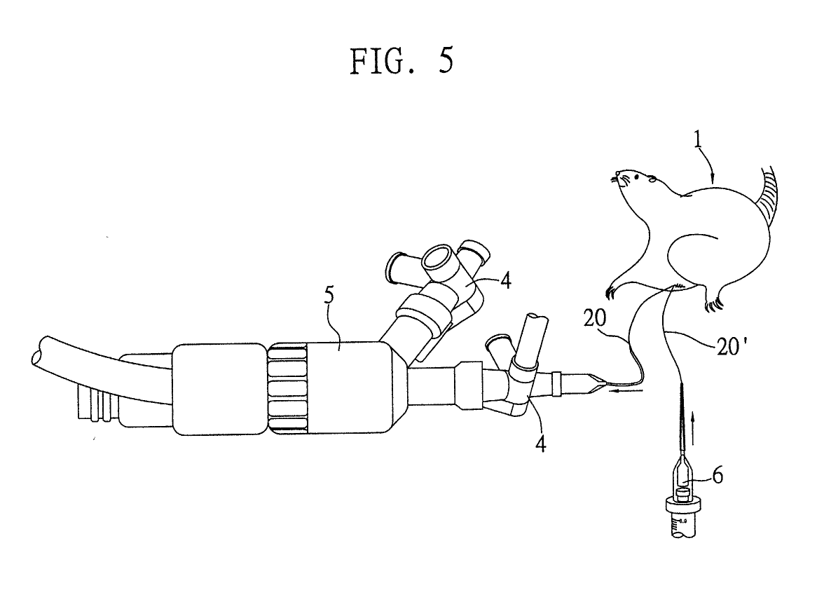

Then, as shown in FIG. 5, an exposed tube portion 20 of a tube 2 connected to a thigh artery (not shown) of the rat 1 is sleeved into a three way adaptor 4 that is linked to a pressure converter 5, which is in turn associated with an external monitoring system (not shown). This allows artery blood of the rat 1 to be easily sampled merely by adjusting pressure and a flow direction of the three way adaptor 4, and thus internal physiological conditions of the live and conscious rat 1 can be instantly monitored through the use of the external monitoring system. At the same time, another exposed tube portion 20′ connected to a thigh vein of the rat 1 can be externally attached with a syringe 6 or a dropper (not shown) for use in nutrient passage or medicine administration.

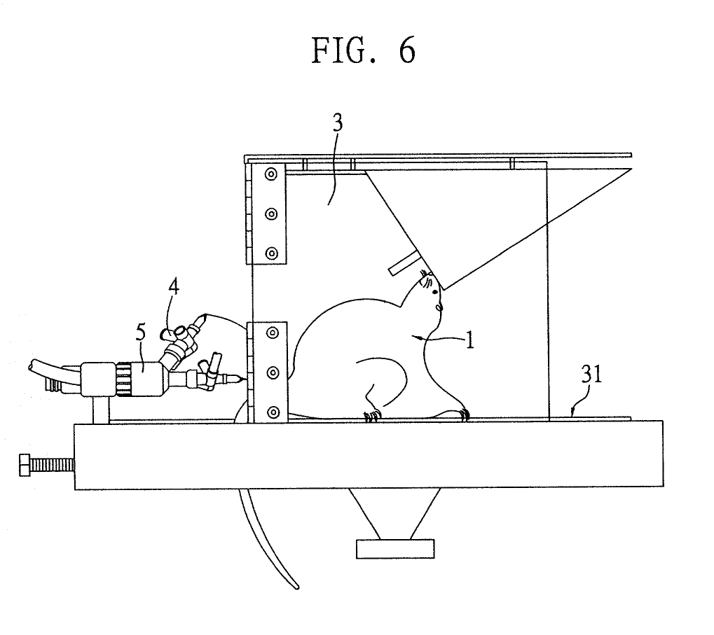

After the rat 1 recovers consciousness, as shown in FIG. 6, the external monitoring system can be used to monitor instant body conditions of the rat 1 such as blood pressure, heartbeat, pulse pressure, electrocardiogram, activity of sympathetic and vice-sympathetic nerves, and various internal biochemical values. After the rat 1 is getting used to the feeding cavity 3 and reaches physical and mental steadiness, experiments can be performed for testing actions and responses of the rat 1 that is subjected to medicine administration or environmental stimuli e.g. electric shocks or temperature variations, depending on experimental purposes. Experimental time is set in response to experimental requirements, and normally more than 72 hours. As the rat 1 stays alive and conscious during the entire experiment, no anesthetic is necessarily applied to the rat 1, and thus external interference with animal physiological mechanisms can be eliminated. Furthermore, since the rat 1 is subjected to experimental tests under physical and mental steadiness, thus undesirable pressure effect on animal internal metabolism is greatly reduced, and experimental results can truly reflect real physiological and pharmaceutical situations of the live rat 1, thereby making experimental data more reliable and significant for use as clinical reference.

Moreover, during proceeding the animal experiment method of the invention, since a plurality of externally-connected tubes are intubated in the rat 1 before test performance, thus rat blood can be easily sampled by adjusting and controlling external devices such as a three way adaptor, without doing harm to live body conditions of the rat 1, so as to prevent undesirable interference with accuracy of internal biochemical values during blood sampling. Besides, in provision of the animal experiment method of the invention, internal physiological and pharmaceutical actions and responses of the rat 1 can be continuously and instantly monitored after medicine administration; this can eliminate the drawback in the prior art of uneasiness in monitoring animal body conditions at different time intervals, and is further advantageous of decreasing the quantity of sacrificed animals and reducing experiment costs, as well as being more compliant to ethical concern.

The invention has been described using exemplary preferred embodiments. However, it is to be understood that the scope of the invention is not limited to the disclosed embodiments. On the contrary, it is intended to cover various modifications and similar arrangements. For example, profiles of rigid boards or barrier walls, or experimental animal species can be altered. The scope of the claims, therefore, should be accorded the broadest interpretation so as to encompass all such modifications and similar arrangements.

What is claimed is:

1. An animal experiment method, comprising the steps of:
preparing a live test animal;
intubating at least one tube into a body of the live test animal, wherein one end of the tube comes into contact with body fluid of the live test animal, and the other end of the tube is exposed to outside of the live test animal;
providing a restriction means for restricting movement of the live test animal within a limited space; and
connecting the exposed end of the tube to a monitoring system, whereby the monitoring system is used to monitor instant physiological conditions of the live test animal under a movement restricted situation.

2. The animal experiment method of claim 1, wherein the live test animal is a rat.

3. The animal experiment method of claim 1, wherein the tube is inserted into a thigh artery of the live test animal.

4. The animal experiment method of claim 1, wherein the restriction means is used to tie up a limb of the live test animal.

5. The animal experiment method of claim 4, wherein the limb is a tail.

6. The animal experiment method of claim 1, wherein the limited space is bordered by a board and a platform.

7. The animal experiment method of claim 6, wherein the board is formed with at least one aperture thereon.

8. The animal experiment method of claim 1, wherein the monitoring system is connected to the tube by a pressure converter.

9. An apparatus for examining physiological conditions of a test animal, comprising:
a platform; and
at least one board vertically positioned on the platform for bordering and forming a first space and a second space, wherein a live test animal intubated with at least a tube therein is placed in the first space, and an exposed portion of the tube is allowed to penetrate through an aperture formed on the board and connected to a monitoring system in the second space, so as to monitor instant physiological conditions of the live test animal.

10. The apparatus of claim 9, wherein the platform is a wire mesh floor.

11. The apparatus of claim 10, wherein the wire mesh floor is formed with a drain hole and a through hole at positions relative to front and rear of the aperture of the board, respectively.

12. The apparatus of claim 9, wherein the board is provided with a movable door.

13. The apparatus of claim 9, wherein the live test animal is a rat.

14. The apparatus of claim 9, wherein the exposed portion of the tube is connected to a three way adaptor.

15. The apparatus of claim 14, wherein the three way adaptor is further connected to a pressure converter of the monitoring system.
